(19) United States
(12) Patent Application Publication
(10) Pub. No.: US 2014/0301800 A1
(43) Pub. Date: Oct. 9, 2014

(54) TOOL SPINDLE

(71) Applicant: Maschinenfabrik Berthold Hermle AG, Gosheim (DE)

(72) Inventors: Franz-Xaver BERNHARD, Spaichingen (DE); Tobias SCHWÖRER, Königsheim (DE); Mathias KAMMERER, Herrenzimmern (DE)

(73) Assignee: Maschinenfabrik Berthold Hermle AG, Gosheim (DE)

(21) Appl. No.: 14/245,960

(22) Filed: Apr. 4, 2014

(30) Foreign Application Priority Data
Apr. 8, 2013 (EP) 13001789.0

(51) Int. Cl. B23Q 11/12

(52) U.S. Cl. CPC B23Q 11/127
USPC 409/135

(57) ABSTRACT

An embodiment includes a two-part power-driven tool spindle that comprises a spindle motor housing in which a first liquid cooling duct extends, a spindle head housing in which a second liquid cooling duct extends, the first and second liquid cooling ducts forming a liquid cooling circuit for a coolant, and a liquid duct, through which the coolant can be conveyed out of the liquid cooling circuit to at least one resealable outlet opening in the spindle head housing and/or in the spindle motor housing. The liquid duct branches off from the second liquid cooling duct in the spindle head housing and/or from the first liquid cooling duct in the spindle motor housing, in such a way that the coolant in the spindle motor housing and the coolant in the spindle head housing can flow out of the tool spindle under gravity.

### CROSS-REFERENCE TO RELATED APPLICATION

This application claims priority to European Patent Application No. 13001789.0, filed Apr. 8, 2013, which is hereby incorporated by reference.

### BACKGROUND

The present disclosure relates to a tool spindle for workpiece machining.

### SUMMARY

One or more embodiments of the present disclosure relate to a two-part power-driven tool spindle for workpiece machining by cutting in a vertical or horizontal machining centre, in particular for milling, drilling and/or turning machining, comprising a spindle motor housing in which a liquid cooling duct extends and comprising a spindle head housing in which a liquid cooling duct extends, the liquid cooling ducts forming a liquid cooling circuit for a coolant.

Within the meaning of one or more embodiments of the present disclosure, the term “two-part power-driven tool spindle” refers to a motor-driven tool spindle which includes the two parts “spindle motor” and “spindle head”. The motor shaft integrated into the spindle motor and the spindle shaft integrated into the spindle head are mounted so as each to be rotatable separately. The torque generated by the spindle motor is transmitted via a coupling to the spindle shaft located in the spindle head. The spindle head can be dismounted for servicing and maintenance work, and can if necessary be replaced with a spindle head of like construction.

Within the meaning of one or more embodiments of the present disclosure, the term “vertical or horizontal machining centre” refers to a machining centre in which the workpiece machining is carried out by the vertically or horizontally orientated tool spindle.

WO 2011/068 637 A1 describes a single-part power-driven tool spindle for a machining centre, which spindle comprises a liquid cooling duct for the spindle motor and a liquid cooling duct for the spindle head, in such a way that not only the spindle motor is cooled, but also the spindle head. The two liquid cooling ducts are interconnected via an interface. However, the disclosed tool spindle is a one-part power-driven tool spindle, which does not have the advantages of particularly simple repair by removing or replacing the spindle head as a separate assembly.

EP 1 609 549 B1 and JP 3-142 142 disclose two-part power-driven tool spindles comprising a liquid cooling duct in the spindle motor housing and a liquid cooling duct in the spindle head housing. For repairing damage to two-part tool spindles of this type having connected liquid cooling ducts in the spindle motor and in the spindle head, it is a drawback that the cooling liquid flows without control, since the liquid cooling circuit is opened when the spindle head has to be dismounted from the rest of the tool spindle for repair work. In this context, the cooling liquid may on the one hand penetrate into the mounting of the spindle head or on the other hand flow off into the working space of the tool spindle, where it contaminates the cooling lubricant of the machining centre.

An object of the present disclosure is to provide a tool spindle of the aforementioned type with which the cooling liquid can be emptied from the liquid cooling circuit before starting to dismount the spindle head. It should be possible to implement this device with low complexity of construction and manufacture.

According to one or more embodiments of the present disclosure, an object of the present disclosure is achieved, in a two-part power-driven tool spindle for workpiece machining by cutting in a vertical or horizontal machining centre, in particular for milling, drilling and/or turning machining, comprising a spindle motor housing in which a liquid cooling duct extends and comprising a spindle head housing in which a liquid cooling duct extends, the liquid cooling ducts forming a liquid cooling circuit for a coolant, in that a liquid duct, through which the coolant can be conveyed out of the liquid cooling circuit to at least one resealable outlet opening in the spindle head housing or in the spindle motor housing, branches off from the liquid cooling duct in the spindle head housing or from the liquid cooling duct in the spindle motor housing, in such a way that the cooling liquid in the spindle motor housing and the cooling liquid in the spindle head housing can flow out of the tool spindle under gravity.

A configuration according to one or more embodiments of the present disclosure provides a simple solution for eliminating the stated drawbacks in a tool spindle of the aforementioned type, in that the cooling liquid can be emptied out of the liquid cooling circuit in a controlled manner through at least one resealable outlet opening before commencing repair work, and thus cannot reach sensitive components of the spindle head or flow out uncontrollably. Further, one or more embodiments of the present disclosure make the procedure for dismounting a spindle head safer and more pleasant for the service technician, since he now has the option of capturing the escaping cooling liquid with a movable container, in such a way that skin contact with the cooling liquid can be largely prevented.

In accordance with one or more embodiments of the present disclosure, the outlet opening is resealable via a manual or power-driven escape valve.

In accordance with one or more embodiments of the present disclosure, the escape valve comprises an electromagnet for opening and a spring for closing.

In accordance with one or more embodiments of the present disclosure, the escape valve may be opened by manual actuation and closed by a spring.

In accordance with one or more embodiments of the present disclosure, the outlet opening is resealable by a plug screw provided with a seal.

In accordance with one or more embodiments of the present disclosure, the outlet opening is installed at the lowest point in the liquid cooling circuit of the spindle head housing.

In accordance with one or more embodiments of the present disclosure, the outlet opening is installed at the lowest point in the liquid cooling circuit of the spindle motor housing.

### BRIEF DESCRIPTION OF THE DRAWINGS

Further details, features and advantages of the present disclosure may be taken from the following description by way of the drawings.

FIG. 1 is a section view through an embodiment of a two-part tool spindle, a spindle motor and a spindle head being assembled.

FIG. 2 is a section through an embodiment of a two-part tool spindle, the spindle motor and the spindle head being separated from one another.

FIG. 3 is a section through an embodiment of the spindle head.

### DETAILED DESCRIPTION

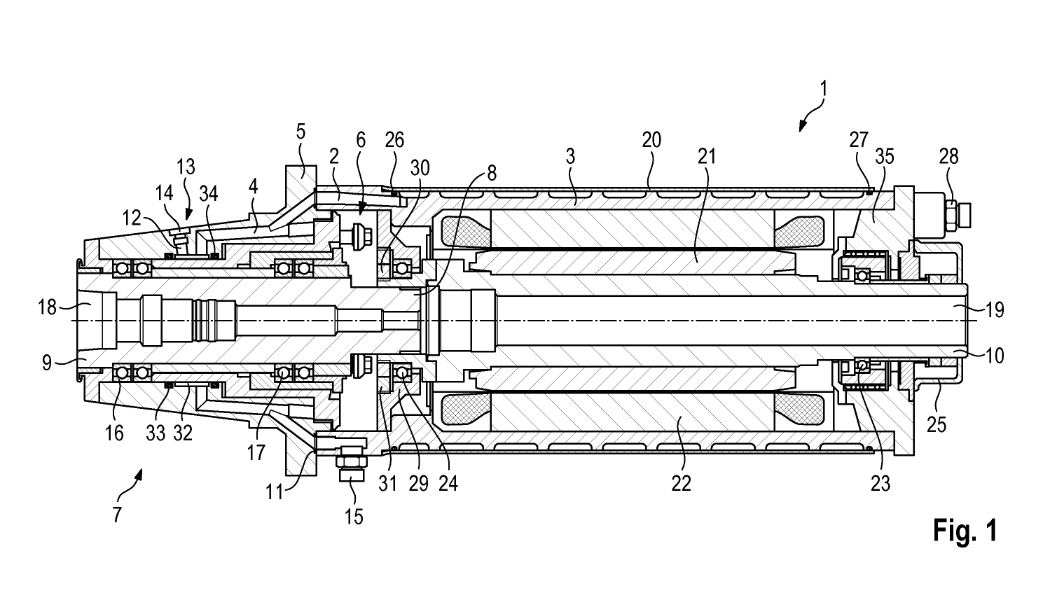

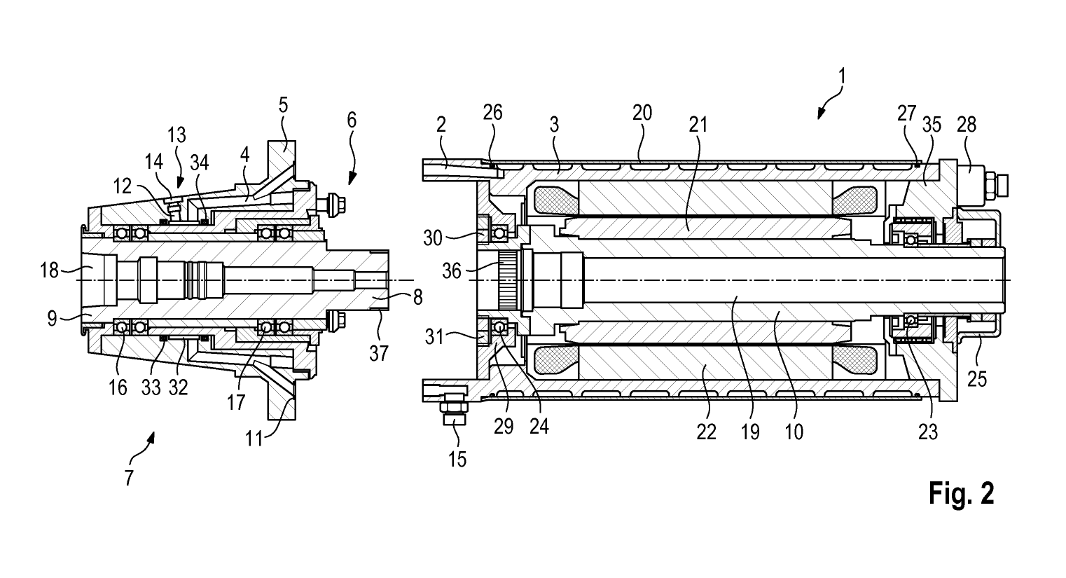

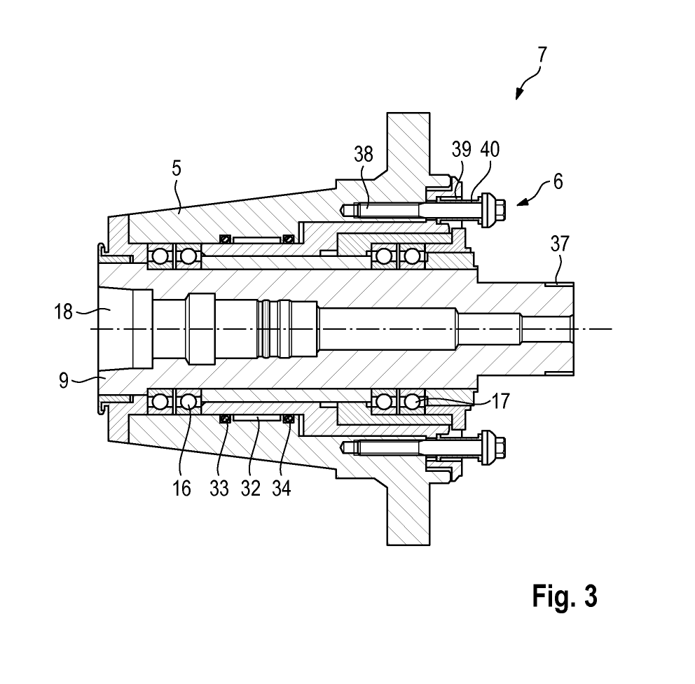

FIGS. 1 to 3 show a two-part power-driven tool spindle which may be used in a vertical machining centre for workpiece machining by cutting, in particular in a multifunctional machining centre for milling, drilling and/or turning machining by cutting.

The two-part tool spindle includes a spindle motor 1 and a spindle head 7.

The spindle motor 1 comprises a tubular spindle motor housing 3 having a substantially cylindrical surface, on which a liquid cooling duct 2 is formed. The liquid cooling duct 2 is externally enclosed by a cooling jacket 20, which is in contact with the spindle motor housing 3 via seals 26 and 27.

A stator 22 is arranged inside the spindle motor housing 3 and encloses a rotor 21. A motor shaft 10 is mounted within the rotor 21 and is provided with a through-hole 19 for receiving a tool clamp.

On the end thereof remote from the spindle head 7, the spindle motor housing 3 comprises a bearing shield 35, on which a roller bearing 23 is held which bears the motor shaft 10. A bearing cover 25 and an axially orientated coolant connector 28 for the return of the coolant are further arranged on the bearing shield 35.

On the end thereof facing the spindle head 7, the spindle motor housing 3 comprises a bearing recess 29, which carries a roller bearing 24 which bears the motor shaft 10. The roller bearing 24 is held on the bearing recess 29 via thread elements 30, 31. The spindle motor housing 3 is further provided, at the end thereof facing the spindle head 7, with a radially orientated coolant connector 15 for the advance of the coolant.

In the region of the end facing the spindle head 7, the motor shaft 10 is provided with a ring gear element 36, which in the embodiment shown is provided with involute toothing, in particular with a spline.

The spindle head 7 comprises a tubular spindle head housing 5 having a substantially frustum-shaped surface. A liquid cooling duct 4 is provided in the spindle head housing 5, and can be connected to the liquid cooling duct 2 in the spindle motor housing 3 via an interface provided with a sealing element 11. The liquid cooling duct 4 in the spindle head housing 5 is connected to a liquid duct 12 which opens into a resealable outlet opening 13, which can be sealed using a plug screw 14 provided with a seal.

During repair work, the cooling fluid can be emptied out of the liquid cooling circuit using this plug screw 14.

As can be seen in FIGS. 1 to 3, a cooling ring 32 is arranged between the liquid cooling duct 4 in the spindle head housing 5 and the liquid duct 12, and is sealed off from the spindle head housing 5 via seals 33 and 34, which are formed for example as rod seals.

A spindle shaft 9 is borne in the spindle head housing 5 via roller bearings 16 and 17, and is provided with a through-hole 18 for receiving a tool clamp. On the end thereof facing the spindle motor housing 3, the spindle shaft 9 comprises an axially displaceable coupling 8, so as to engage the spindle shaft 9 with the motor shaft 10. For this purpose, the end of the spindle shaft 9 facing the motor shaft 10 is provided with a tooth hub 37, which in the embodiment shown is provided with involute toothing, in particular with a spline. When coupled in, this tooth hub 37 engages in the ring gear element 36 provided on the motor shaft 10.

In the embodiment shown, the connection between the spindle shaft 9 and the motor shaft 10 is in the form of involute toothing, in particular comprising a spline, but it may also be implemented using other types of connections, for example using a pin coupling, a polygonally profiled coupling, a claw coupling, etc.

An axially deformable impact protector 6 is further arranged in the spindle head housing 5, and serves to absorb potential collision forces if the machine crashes. The impact protector 6 comprises a clamping screw 38, which is arranged in a recess 39 in the spindle head housing 5, projects past the spindle head housing 5 in the axial direction and is provided with a compression sleeve 40 in the projecting region thereof.

In the embodiment shown in the drawings, the liquid duct 12 and the outlet opening 13 are arranged in the spindle head housing 5. However, an embodiment in which the liquid duct 12 and the outlet opening 13 are arranged in the spindle motor housing 3 is also conceivable.

In some embodiments, the outlet opening 13 is installed at the lowest point either in the liquid cooling duct 4 of the spindle head housing 5 or in the liquid cooling duct 2 of the spindle motor housing 3.

The outlet opening 13 may further also be provided with a power-actuated escape valve. For example, an electromagnet for opening and a spring for closing may be provided. Alternatively, the escape valve may also be opened by manual actuation and closed by a spring.

One or more embodiments of the present disclosure relate to a two-part power-driven tool spindle for workpiece machining by cutting in a vertical or horizontal machining centre, in particular for milling, drilling and/or turning machining, comprising a spindle motor housing (3) in which a liquid cooling duct (2) extends and comprising a spindle head housing (5) in which a liquid cooling duct (4) extends, the liquid cooling ducts (2, 4) forming a liquid cooling circuit for a coolant. So as to provide a tool spindle with which the cooling liquid can be emptied from the liquid cooling circuit before starting to dismount the spindle head and which can be implemented with low complexity of construction and manufacture, the present disclosure provides that a liquid duct (12), through which the coolant can be conveyed out of the liquid cooling circuit to at least one resealable outlet opening (13) in the spindle head housing (5) or in the spindle motor housing (3), branches off from the liquid cooling duct (4) in the spindle head housing (5) or from the liquid cooling duct (2) in the spindle motor housing (3), in such a way that the cooling liquid in the spindle motor housing (3) and the cooling liquid in the spindle head housing (5) can flow out of the tool spindle under gravity.

One or more embodiments of the present disclosure may include one or more of the following concepts:
A. Two-part power-driven tool spindle for workpiece machining by cutting in a vertical or horizontal machining centre, in particular for milling, drilling and/or turning machining, comprising a spindle motor housing (3) in which a liquid cooling duct (2) extends and comprising a spindle head housing (5) in which a liquid cooling duct (4) extends, the liquid cooling ducts (2, 4) forming a liquid cooling circuit for a coolant, characterised in that a liquid duct (12), through which the coolant can be conveyed out of the liquid cooling circuit to at least one resealable outlet opening (13) in the spindle head housing (5) or in the spindle motor housing (3), branches off from the liquid cooling duct (4) in the spindle head housing (5) or from the liquid cooling duct (2) in the spindle motor housing (3), in such a way that the cooling liquid in the spindle motor housing (3) and the cooling liquid in the spindle head housing (5) can flow out of the tool spindle under gravity.
B. Tool spindle according to Paragraph A, characterised in that the outlet opening (13) is resealable via a manual or power-driven escape valve.
C. Tool spindle according to Paragraph B, characterised in that the escape valve comprises an electromagnet for opening and a spring for closing.
D. Tool spindle according to Paragraph B, characterised in that the escape valve is to be opened by manual actuation and closed by a spring.
E. Tool spindle according to Paragraph A, characterised in that the outlet opening (13) is resealable by means of a plug screw (14) provided with a seal.
F. Tool spindle according to any one of the preceding Paragraphs, characterised in that the outlet opening (13) is installed at the lowest point in the liquid cooling circuit (4) of the spindle head housing (5).
G. Tool spindle according to any one of the preceding Paragraphs, characterised in that the outlet opening (13) is installed at the lowest point in the liquid cooling circuit (2) of the spindle motor housing (3).

One or more embodiments of the present disclosure may include one or more of the following features, which correspond to reference numerals in the drawings:
1 Spindle motor
2 Liquid cooling duct in the spindle motor housing
3 Spindle motor housing
4 Liquid cooling duct in the spindle head housing
5 Spindle head housing
6 Impact protector
7 Spindle head
8 Coupling
9 Spindle shaft
10 Motor shaft
11 Sealing element
12 Liquid duct
13 Outlet opening
14 Plug screw
15 Advance coolant connector
16 Roller bearing
17 Roller bearing
18 Through-hole
19 Through-hole
20 Cooling jacket
21 Rotor
22 Stator
23 Roller bearing
24 Roller bearing
25 Bearing cover
26 Seal
27 Seal
28 Return coolant connector
29 Bearing recess
30 Threaded elements
31 Threaded elements
32 Cooling ring
33 Seal
34 Seal
35 Bearing shield
36 Ring gear element
37 Tooth hub
38 Clamping screw
39 Recess
40 Compression sleeve

The above description of the present invention is merely for illustrative purposes, and does not serve to limit the invention. Various changes and modifications are possible without the context of the invention, without departing from the scope of the invention and of the equivalent thereof.

What is claimed is:

1. A two-part power-driven tool spindle, comprising:
a spindle motor housing in which a first liquid cooling duct extends,
a spindle head housing in which a second liquid cooling duct extends, the first and second liquid cooling ducts forming a liquid cooling circuit for a coolant, and
a liquid duct, through which the coolant can be conveyed out of the liquid cooling circuit to at least one resealable outlet opening in the spindle head housing and/or in the spindle motor housing,
wherein the liquid duct branches off from the second liquid cooling duct in the spindle head housing and/or from the first liquid cooling duct in the spindle motor housing, in such a way that the coolant in the spindle motor housing and the coolant in the spindle head housing can flow out of the tool spindle under gravity.

2. The tool spindle of claim 1, wherein the outlet opening is resealable via a manual or a power-driven escape valve.

3. The tool spindle of claim 2, wherein the escape valve comprises an electromagnet for opening and a spring for closing.

4. The tool spindle of claim 2, wherein the escape valve is to be opened by manual actuation and closed by a spring.

5. The tool spindle of claim 1, wherein the outlet opening is resealable by a plug screw provided with a seal.

6. The tool spindle of claim 1, wherein the outlet opening is installed at a lowest point in the liquid cooling circuit of the spindle head housing.

7. The tool spindle of claim 1, wherein the outlet opening is installed at a lowest point in the liquid cooling circuit of the spindle motor housing.

8. The tool spindle of claim 1, wherein the tool spindle adapted for workpiece machining is adapted for cutting in a vertical or horizontal machining centre.

9. The tool spindle of claim 8, wherein the tool spindle is adapted for milling, drilling and/or turning machining.

10. A power-driven tool spindle, comprising:
a first section having a spindle motor housing in which a first liquid cooling duct extends,
a second section, different from the first section, having a spindle head housing in which a second liquid cooling duct extends, the first and second liquid cooling ducts in fluid communication forming a liquid cooling circuit for a coolant, and
a liquid duct, through which the coolant can be conveyed out of the liquid cooling circuit to a resealable outlet opening in the spindle head housing,
wherein the liquid duct is configured in such a way that the coolant in the spindle motor housing and the coolant in the spindle head housing can flow out of the outlet opening of the tool spindle under gravity.

11. The tool spindle of claim 10, wherein the tool spindle adapted for workpiece machining is adapted for cutting in a vertical or horizontal machining centre.

12. The tool spindle of claim 11, wherein the tool spindle is adapted for milling, drilling and/or turning machining.

13. The tool spindle of claim 12, wherein the outlet opening is installed in one of at a lowest point in the liquid cooling circuit of the spindle head housing and at a lowest point in the liquid cooling circuit of the spindle motor housing.

14. The tool spindle of claim 13, wherein the outlet opening is resealable via an escape valve that comprises an electromagnet for opening and a spring for closing.

15. The tool spindle of claim 13, wherein the outlet opening is resealable via an escape valve to be opened by manual actuation and closed by a spring.

16. The tool spindle of claim 13, wherein the outlet opening is resealable by a plug screw provided with a seal.

17. A two-part tool spindle, comprising:
a spindle motor housing in which a first liquid cooling duct extends,
a spindle head housing in which a second liquid cooling duct extends, the first and second liquid cooling ducts in fluid communication forming a liquid cooling circuit for a coolant, and
a liquid duct, through which the coolant can be conveyed out of the liquid cooling circuit to a resealable outlet opening in the spindle motor housing,
wherein the liquid duct branches off from the second liquid cooling duct in the spindle head housing and/or from the first liquid cooling duct in the spindle motor housing in such a way that the coolant in the spindle motor housing and the coolant in the spindle head housing can flow out of the outlet opening of the tool spindle under gravity.

18. The tool spindle of claim 17, wherein the outlet opening is resealable via an escape valve that comprises an electromagnet for opening and a spring for closing.

19. The tool spindle of claim 17, wherein the outlet opening is resealable via an escape valve that is to be opened by manual actuation and closed by a spring.

20. The tool spindle of claim 17, wherein the outlet opening is installed in one of at a lowest point in the liquid cooling circuit of the spindle head housing and at a lowest point in the liquid cooling circuit of the spindle motor housing.
